(19) United States
(12) Patent Application Publication
(10) Pub. No.: US 2008/0256043 A1
(43) Pub. Date: Oct. 16, 2008

(54) ACCUMULATION CONTROL DEVICE

(75) Inventor: Katsushi Minamino, Kyoto (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA MACHINERY, LTD., Kyoto-shi (JP)

(21) Appl. No.: 12/101,531

(22) Filed: Apr. 11, 2008

(30) Foreign Application Priority Data
Apr. 13, 2007 (JP) 2006-106022

(51) Int. Cl. G06F 7/06; G06F 17/30

(52) U.S. Cl. 707/3; 707/E17.014

(57) ABSTRACT

An accumulation control device arranged to accumulate data in an accumulation device accepts a data classification when the data is acquired, and stores the accepted classification in accordance with the data to be accumulated in the accumulation device. When the data accumulated in the accumulation device is selected, determination is made as to whether or not a current time is a timing at which an accumulation form of the accumulated data should be changed, and when determination is made that the timing has come, the selected data is reaccumulated in the accumulation device, in the accumulation form stored in an accumulation-form storage unit in association with the accepted classification and the determined timing.

### CROSS-REFERENCE TO RELATED APPLICATIONS

This application claims priority under 35 U.S.C. 119 to Japanese Patent Application No. 2007-106022, filed on Apr. 13, 2007, which application is hereby incorporated by reference in its entirety.

### BACKGROUND OF THE INVENTION

1. Field of the Invention

The present invention relates to an accumulation control device for controlling data accumulation and data reaccumulation.

2. Description of the Related Art

An accumulation control device has been conventionally known. The accumulation control device accumulates computerized data in an accumulation unit such as a hard disk arranged in the accumulation control device or in an accumulation unit such as a file server arranged outside the accumulation control device.

A data accumulation area of such accumulation units has limitations. Therefore, it is preferable that the data accumulation area occupied by one piece of data is reduced by having the data accumulated in the accumulation unit after an amount of data is reduced in advance. Moreover, it is preferable that the data accumulation area occupied by one piece of data is further reduced by having the data reaccumulated in the accumulation unit after the amount of data is further reduced in accordance with a time elapsed from a time when the data is accumulated. In a monitor-image accumulation device of a conventional technique, a data compression process carried out by thinning image data is repeated in accordance with a time elapsed from a time of image data accumulation.

### SUMMARY OF THE INVENTION

However, in the accumulation control device such as the monitor-image accumulation device of the above-described conventional technique, there exists a problem that a user cannot specify an appropriate accumulation form and timing at which the accumulation form should be changed, with respect to each data to be accumulated. Nevertheless, in order to overcome the above problem, if the user instructs the accumulation control device each time on the accumulation form that is appropriate for the data to be accumulated and on the appropriate timing at which the accumulation form should be changed, user convenience is diminished.

Even in an accumulation control device for which the user can specify the accumulation form, it is preferable that the user can change the already specified accumulation form. However, when the user unnecessarily changes the already specified accumulation form, a problem can arise in that data of particularly high importance cannot be appropriately accumulated.

In order to overcome the above-described problems, a preferred embodiment of the present invention provides an accumulation control device that stores in advance a timing at which an accumulation form of data should be changed and the accumulation form after the change in association with a data classification, and that reaccumulates the accumulated data in the accumulation form in accordance with the classification accepted when the data is acquired, so that a user can easily specify, at the time of data acquisition, the accumulation form that is appropriate for the accumulated data and the appropriate timing at which the accumulation form should be changed.

Another preferred embodiment of the present invention provides the accumulation control device that accepts the accumulation form of the data and accumulates or reaccumulates the data in the accepted accumulation form so that the user can directly specify the accumulation form.

Another preferred embodiment of the present invention provides the accumulation control device that prohibits or executes the acceptance of the accumulation form in accordance with a degree of importance of the data so as to prevent a problem in which data of high importance is accumulated or reaccumulated in an inappropriate accumulation form.

Yet another preferred embodiment of the present invention provides the accumulation control device that stores in advance the accumulation form of the data in association with the data classification and accumulates the acquired data in the accumulation form in accordance with the classification accepted at the time of data acquisition, so that the user can easily specify the appropriate accumulation form of the acquired data at the time of data acquisition.

The accumulation control device according to the preferred embodiments of the present invention includes an acquiring unit that acquires data and a first accumulation control unit that accumulates in an accumulation unit the data acquired by the acquiring unit. The accumulation control device further includes a classification accepting unit, a classification storage unit, an accumulation-form storage unit, a selection unit, a timing determining unit, and a second accumulation control unit. The classification accepting unit accepts the data classification when the data is acquired by the acquiring unit. The classification storage unit stores the classification accepted by the classification accepting unit, in accordance with the data to be accumulated in the accumulation unit. The accumulation-form storage unit stores the data classification, the timing at which the accumulation form of the accumulated data should be changed, and the accumulation form of the data after the change, in association with each other. The selection unit selects the data accumulated in the accumulation unit. The timing determining unit determines whether or not the timing stored in the accumulation-form storage unit in association with the classification stored in the classification storage unit has come, in accordance with the data selected by the selection unit. When the timing determining unit determines that the timing has come, the second accumulation control unit reaccumulates in the accumulation unit the data selected by the selection unit, in the accumulation form stored in the accumulation-form storage unit in association with the classification and the timing determined by the timing determining unit.

According to the preferred embodiments of the present invention, the acquiring unit acquires the data. When the data is acquired by the acquiring unit, the classification accepting unit accepts the classification of the data acquired by the acquiring unit. The classification accepted by the classification accepting unit is stored in the classification storage unit in accordance with the data to be accumulated in the accumulation unit. The first accumulation control unit accumulates in the accumulation unit the data acquired by the acquiring unit. The accumulation-form storage unit stores in advance the data classification, the timing at which the accumulation form of the accumulated data should be changed, and the accumulation form of the data after the change, in association with each other.

The selection unit properly selects the data accumulated in the accumulation unit. Then, by referring to the classification storage unit, the classification in accordance with the data selected by the selection unit can be acquired. By referring to the accumulation-form storage unit, the timing in association with the classification acquired from the classification storage unit can be acquired. The timing determining unit determines whether or not the timing acquired from the accumulation-form storage unit has come. When the timing determining unit determines that the timing acquired from the accumulation-form storage unit has come, by referring to the accumulation-form storage unit, the accumulation form in association with the classification acquired from the classification storage unit and with the timing acquired from the accumulation-form storage unit can be acquired. The second accumulation control unit reaccumulates in the accumulation unit the data selected by the selection unit, in the accumulation form acquired from the accumulation-form storage unit.

In other words, when the user of the accumulation control device gives the data classification to the classification accepting unit, the data changed into the appropriate accumulation form that is in association with the data classification is reaccumulated in the accumulation unit at the appropriate timing that is in association with the data classification. When the timing determining unit determines that the timing acquired from the accumulation-form storage unit has not come, the change of the accumulation form and the reaccumulation are not performed.

According to the preferred embodiments of the present invention, the user does not have to give each time the accumulation form of the data and the timing at which the accumulation form should be changed. Moreover, simply by giving the data classification to the accumulation control device, the user can easily specify the accumulation form appropriate for the data to be reaccumulated and the appropriate timing at which the accumulation form should be changed. Therefore, while the accumulated data can be changed at the appropriate timing into the appropriate accumulation form and reaccumulated, the user convenience can also be improved.

The accumulation control device according to the preferred embodiments of the present invention includes an accumulation-form accepting unit that accepts the accumulation form of the accumulated data and the form-acceptance determining unit that determines whether or not the accumulation-form accepting unit has accepted the accumulation form. When the form-acceptance determining unit determines that the accumulation form has been accepted, and when the timing determining unit determines that the timing has come, the second accumulation control unit reaccumulates in the accumulation unit the data selected by the selection unit, in the accumulation form accepted by the accumulation-form accepting unit.

According to the preferred embodiments of the present invention, the accumulation-form accepting unit accepts the accumulation form of the accumulated data, and the form-acceptance determining unit determines whether or not the accumulation-form accepting unit has accepted the accumulation form. When the form-acceptance determining unit determines that the accumulation form has been accepted, and when the timing determining unit determines that the timing stored in the accumulation-form storage unit has come, the second accumulation control unit reaccumulates in the accumulation unit the data selected by the selection unit, in the accumulation form accepted by the accumulation-form accepting unit.

In other words, when the user of the accumulation control device gives the accumulation form of the data to the accumulation-form accepting unit, the accumulation form directly specified by the user is used in priority to the initially set accumulation form stored in the accumulation-form storage unit, and the data is reaccumulated in the accumulation unit in the directly specified accumulation form. When the form-acceptance determining unit determines that the accumulation form has not been accepted, and when the timing determining unit determines that the timing stored in the accumulation-form storage unit has come, the second accumulation control unit reaccumulates in the accumulation unit the data selected by the selection unit, in the initially set accumulation form. Thus, the initially set accumulation form and the accumulation form directly specified by the user can be separately used properly.

According to the preferred embodiments of the present invention, the user can directly specify the accumulation form of the data. In other words, the initially set accumulation form can be changed to any accumulation form chosen by the user. Thus, the data can be accumulated or reaccumulated in the more appropriate accumulation form.

In the accumulation control device according to a further preferred embodiment of the present invention, at least the degree of importance of the data is included in the classification to be accepted by the classification accepting unit, or the degree of importance of the data is stored in the accumulation-form storage unit in association with the data classification, and thus, the acceptance of the accumulation form by the accumulation-form accepting unit is prohibited or executed in accordance with the degree of importance of the data.

According to the preferred embodiments of the present invention, the classification accepting unit accepts the data classification including at least the degree of importance of the data. When the degree of importance of the data included in the classification accepted by the classification accepting unit is high, the accumulation-form accepting unit does not accept the accumulation form of the data. When the degree of importance of the data included in the classification accepted by the classification accepting unit is low, the accumulation-form accepting unit accepts the accumulation form of the data.

Alternatively, the accumulation-form storage unit stores in advance the data classification, the timing at which the accumulation form of the accumulated data should be changed, the accumulation form of the data after the change, and the degree of importance of the data, in association with each other. When the degree of importance of the data stored in the accumulation-form storage unit in association with the classification accepted by the classification accepting unit is high, the accumulation-form accepting unit does not accept the accumulation form of the data. When the degree of importance of the data stored in the accumulation-form storage unit in association with the classification accepted by the classification accepting unit is low, the accumulation-form accepting unit accepts the accumulation form of the data.

Thus, with respect to the data of low importance, the initially set accumulation form and the accumulation form directly specified by the user can be separately used properly, and with respect to the data of high importance, only the initially set accumulation form is applied.

According to the preferred embodiments of the present invention, when the degree of importance of the data is high, the user is prevented from unnecessarily changing the initially set accumulation form, and when the degree of importance of the data is low, the user can change the accumulation form. Thus, improvement can be achieved in that the accumulation form with respect to the data of low importance is freely specified, and also a problem in which the data of high importance is accumulated or reaccumulated in an inappropriate accumulation form can be prevented.

The accumulation control device according to a further preferred embodiment of the present invention includes an initial-form storage unit that stores the data classification and the accumulation form of the data to be acquired, in association with each other. The first accumulation control unit accumulates in the accumulation unit the data acquired by the acquiring unit, in the accumulation form stored in the initial-form storage unit in association with the classification accepted by the classification accepting unit.

According to the preferred embodiments of the present invention, the data classification and the accumulation form of the data to be acquired are stored in advance in association with each other in the initial-form storage unit. Then, the acquiring unit acquires the data, and accompanying the data acquisition by the acquiring unit, the classification accepting unit accepts the classification of the data acquired by the acquiring unit. The classification accepted by the classification accepting unit is stored in the classification storage unit in accordance with the data to be accumulated in the accumulation unit. Further, by referring to the initial-form storage unit, the accumulation form in association with the classification acquired from the classification storage unit can be acquired. The first accumulation control unit accumulates in the accumulation unit the data acquired by the acquiring unit, in the accumulation form acquired from the accumulation-form storage unit.

In other words, when the user of the accumulation control device gives the data classification to the classification accepting unit, the data can be accumulated in the accumulation unit in the appropriate accumulation form that is in association with the data classification.

According to the preferred embodiments of the present invention, simply by giving the data classification to the device, the user can easily specify the accumulation form appropriate for the data to be accumulated. Thus, the acquired data can be accumulated in the appropriate accumulation form, and the user convenience can be also improved.

The accumulation control device according to a further preferred embodiment of the present invention includes an initial-form accepting unit that accepts, at the time of data acquisition by the acquiring unit, the accumulation form of the data to be acquired, and includes an initial-acceptance determining unit that determines whether or not the initial-form accepting unit has accepted the accumulation form. When the initial-acceptance determining unit determines that the accumulation form has been accepted, the first accumulation control unit accumulates in the accumulation unit the data acquired by the acquiring unit, in the accumulation form accepted by the initial-form accepting unit.

According to the preferred embodiments of the present invention, the initial-form accepting unit accepts, at the time of data acquisition by the acquiring unit, the accumulation form of the data to be acquired, and the initial-acceptance determining unit determines whether or not the initial-form accepting unit has accepted the accumulation form. When the initial-acceptance determining unit determines that the accumulation form has been accepted, the first accumulation control unit accumulates in the accumulation unit the data acquired by the acquiring unit, in the accumulation form accepted by the initial-form accepting unit.

In other words, when the user of the accumulation control device gives the accumulation form of the data to the initial-acceptance determining unit, the accumulation form directly specified by the user is used in priority to the initially set accumulation form stored in the initial-form storage unit, and the data is accumulated in the accumulation unit in the directly specified accumulation form. When the initial-acceptance determining unit determines that the accumulation form has not been accepted, the first accumulation control unit accumulates in the accumulation unit the data acquired by the acquiring unit, in the initially set accumulation form. Thus, the initially set accumulation form and the accumulation form directly specified by the user can be separately used properly.

According to the preferred embodiments of the present invention, the user can directly specify the accumulation form of the data. That is, the initially set accumulation form can be changed into any accumulation form chosen by the user. Thus, the data can be accumulated or reaccumulated in the more appropriate accumulation form.

In the accumulation control device according to a further preferred embodiment of the present invention, at least the degree of importance of the data is included in the classification to be accepted by the classification accepting unit, or the degree of importance of the data is stored in the initial-form storage unit in association with the data classification, and thus, the acceptance of the accumulation form by the initial-form accepting unit is prohibited or executed in accordance with the degree of importance of the data.

According to the preferred embodiments of the present invention, the classification accepting unit accepts the data classification including at least the degree of importance of the data. When the degree of importance of the data included in the classification accepted by the classification accepting unit is high, the initial-form accepting unit does not accept the accumulation form of the data. When the degree of importance of the data included in the classification accepted by the classification accepting unit is low, the initial-form accepting unit accepts the accumulation form of the data.

Alternatively, the data classification, the accumulation form of the data to be acquired, and the degree of importance of the data are stored in advance in association with each other in the initial-form storage unit. When the degree of importance of the data stored in the initial-form storage unit in association with the classification accepted by the classification accepting unit is high, the initial-form accepting unit does not accept the accumulation form of the data. When the degree of importance of the data stored in the initial-form storage unit in association with the classification accepted by the classification accepting unit is low, the initial-form accepting unit accepts the accumulation form of the data.

Thus, with respect to the data of low importance, the initially set accumulation form and the accumulation form directly specified by the user can be separately used properly, and with respect to the data of high importance, only the initially set accumulation form is applied.

According to the preferred embodiments of the present invention, when the degree of importance of the data is high, the user is prevented from unnecessarily changing the initially set accumulation form, and when the degree of importance of the data is low, the accumulation form can be changed by the user. Thus, improvement can be achieved in that the accumulation form with respect to the data of low importance is freely specified, and a problem in which the data of high importance is accumulated or reaccumulated in an inappropriate accumulation form can be prevented.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a structure of a Multi Function Peripheral (MFP) as an accumulation control device according to a preferred embodiment of the present invention.

FIG. 2 illustrates an example of data stored in an accumulation-form storage unit provided in the MFP according to the preferred embodiment of the present invention.

FIG. 3 is a schematic view illustrating an example of data stored in a classification storage unit provided in the MFP according to the preferred embodiment of the present invention.

FIG. 4 is a flow chart illustrating a procedure of an initial accumulation process executed by a Central Processing Unit (CPU) of the MFP according to the preferred embodiment of the present invention.

FIG. 5 is a flow chart illustrating a procedure of a reaccumulation process executed by the CPU of the MFP according to the preferred embodiment of the present invention.

### DETAILED DESCRIPTION OF PREFERRED EMBODIMENTS

The present invention will be described in detail with reference to the drawings illustrating a preferred embodiment thereof.

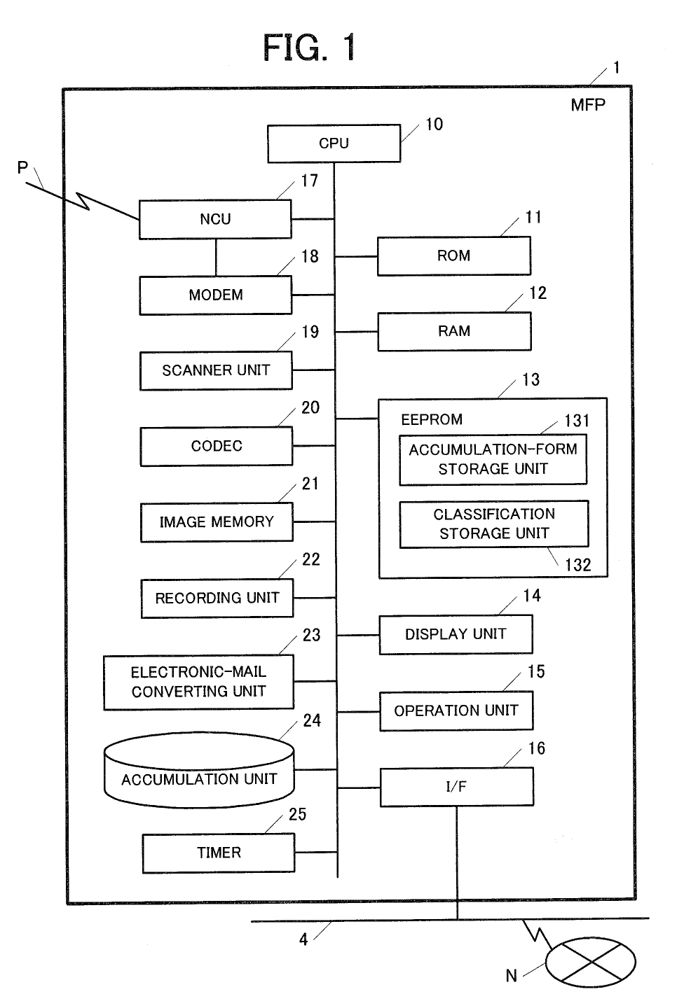

FIG. 1 is a block diagram illustrating a structure of an MFP as an accumulation control device according to a preferred embodiment of the present invention. In FIG. 1, reference numeral 1 denotes a digital MFP. The MFP 1 includes a plurality of functions such as a scanner function, a printer function, a copier function, a facsimile (hereinafter referred to as a FAX) function, an Internet FAX (hereinafter referred to as an I-FAX) function, and a file server function. The MFP 1 is also provided with a FAX number, a mail address, and an Internet Protocol (IP) address etc.

The MFP 1 includes a CPU 10, a Read Only Memory (ROM) 11, a Random Access Memory (RAM) 12, an Electronically Erasable and Programmable Read Only Memory (EEPROM) 13, a display unit 14, an operation unit 15, an Interface (I/F) 16, a Network Control Unit (NCU) 17, a modem 18, a scanner unit 19, a coder decoder (CODEC) 20, an image memory 21, a recording unit 22, an electronic-mail converting unit 23, an accumulation unit 24, and a timer 25. The MFP 1 is connected to a Local Area Network (LAN) 4 via the I/F 16. The MFP 1 is connected to an Internet N via the LAN 4. The MFP 1 is also connected to a telephone line P via the NCU 17. In the present preferred embodiment, the I/F 16 functions as an acquiring unit to receive various data via the LAN 4.

The MFP 1 and a FAX machine (not illustrated) that is connected to the telephone line P operate in accordance with a protocol of an International Telecommunication Union Telecommunication (ITU-T) Recommendation T.30 communication standard. In other words, both the MFP 1 and the FAX machine transmit and receive image data for FAX communication (hereinafter referred to as FAX image data) in accordance with a prescribed protocol defined by the Recommendation. When receiving the FAX image data, the MFP 1 also receives a FAX number of a FAX machine which is a source of the FAX image data. Moreover, both the MFP 1 and a personal computer (not illustrated) that is connected to the LAN 4 transmit and receive a file such as a document file and an image file in accordance with the prescribed protocol.

Further, both the MFP 1 and an I-FAX machine (not illustrated) that is connected to the Internet N transmit and receive an electronic mail for I-FAX communication (hereinafter referred to as a FAX mail) in accordance with a prescribed protocol (for example, a Simple Mail Transfer Protocol: SMTP). The FAX mail includes image data (for example, data in a Portable Document Format (PDF) form and data of a document edited by using word-processing software etc. that are coded by using a prescribed coding system. Hereinafter, the image data will be referred to as I-FAX image data); a mail address of the I-FAX machine which is a source of the FAX mail; a mail address of the MFP 1 which is a destination; and a header having information on the coding system etc. of the I-FAX image data, all of which are used for the I-FAX communication. Both the I-FAX image data and the header use text data.

The CPU 10 uses the PAM 12 as a work area. The CPU 10 controls each unit of the device and executes various processes in accordance with a control program and data that are stored in the ROM 11 and with data stored in the EEPROM 13. For example, the CPU 10 inputs the I-FAX image data included in the FAX mail into the electronic-mail converting unit 23, and converts the data into image data (hereinafter referred to as original image data) that is not coded by using a prescribed coding system (for example, a Multipurpose Internet Mail Extension (MIME) base 64).

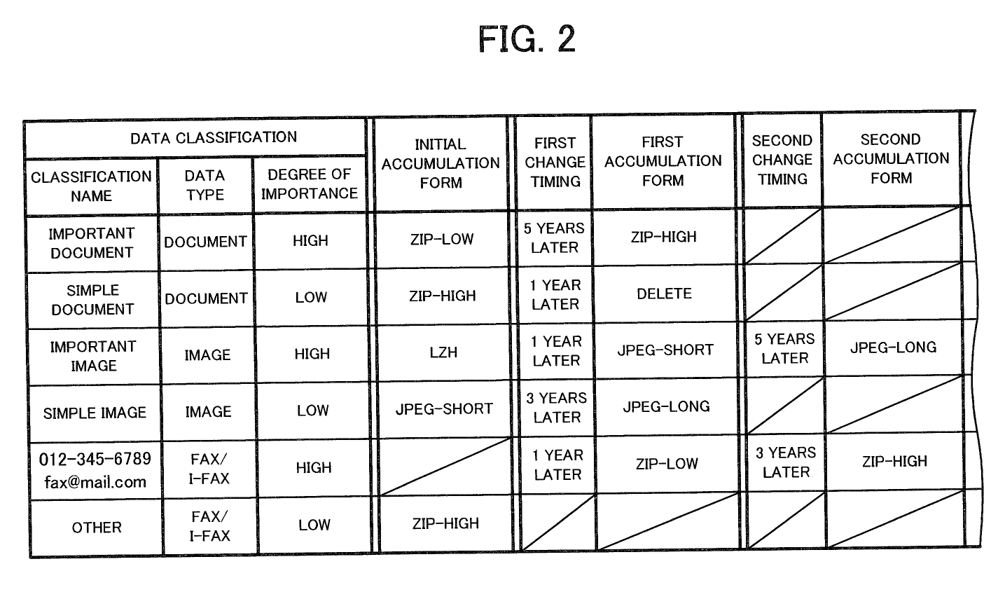

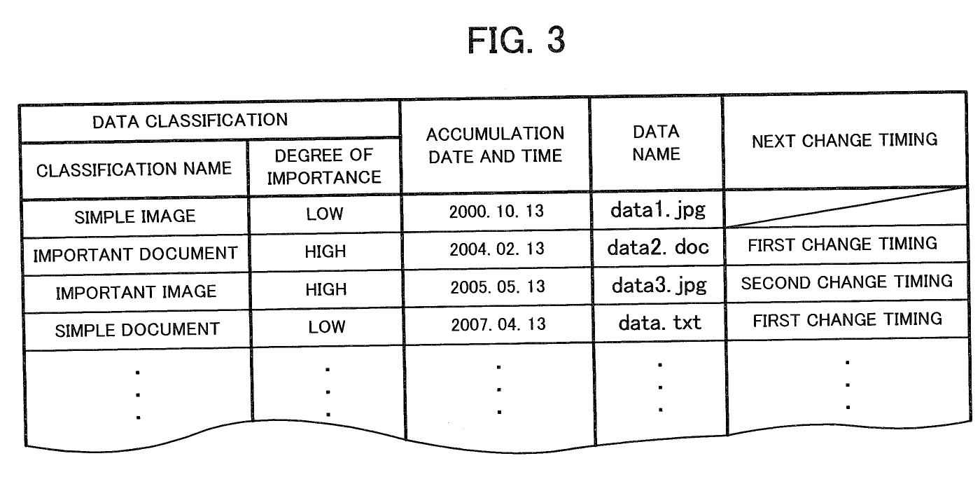

The RAM 12 temporarily stores the received data (to be more precise, various files received from the personal computer and the FAX mail received from the I-FAX machine). A portion of a storage area in the EEPROM 13 is an accumulation-form storage unit 131 as illustrated in FIG. 2 (described later), and another portion of the storage area in the EEPROM 13 is a classification storage unit 132 as illustrated in FIG. 3 (described later).

A liquid crystal panel can be used for the display unit 14. The operation unit 15 includes various function keys. A hard key and a soft key that is generated by the CPU 10, on a touchscreen laminated on the display unit 14, are used as the function keys. The display unit 14 is controlled by the CPU 10 and displays, for example, operational status of the MFP 1, input instructions for a user, and an image that represents a position of the soft key arranged on the operation unit 15, or the like. The user of the MFP 1 operates the various function keys of the operation unit 15 while checking the display unit 14. The NCU 17 performs line control of the telephone line P. The modem 18 transmits and receives the FAX image data to and from the FAX machine via the telephone line P. The modem 18 functions as an acquiring unit to receive the FAX image data.

The scanner unit 19 functions as an acquiring unit and includes an original-document transporting unit (not illustrated). In the scanner unit 19, an original document placed on an image scanning position or an original document transported by the original document transporting unit to the image scanning position is optically scanned, thereby generating the original image data. The CODEC 20 performs coding of the original image data and decoding of the FAX image data by using the prescribed coding system. The image memory 21 uses a Dynamic Random Access Memory (DRAM) and stores the FAX image data and/or the original image data. In other words, the image memory 21 temporarily stores the received data (more precisely, the FAX image data received from the FAX machine) and/or the original image data acquired by having the original document scanned by the scanner unit 19.

The recording unit 22 includes an electrophotographic printer device and a paper feeding device for supplying the printer device with recording papers. In the recording unit 22, an image is formed (recorded) on the recording paper in accordance with the original image data stored in the image memory 21. The accumulation unit 24 uses a relatively-high-capacity storage unit such as the EEPROM and a hard disk. The timer 25 counts current date and time.

The MFP 1 accumulates in the accumulation unit 24 the data acquired by scanning by the scanner unit 19, the data received by using the modem 18, and the data received via the I/F 16 (that is, the acquired data), and reaccumulates the data after an accumulation form of each of the accumulated data is changed at a prescribed timing. The original data before the reaccumulation is deleted. When the data is acquired, the data may be compressed to be accumulated, or may be accumulated without being compressed. The change of the accumulation form may be performed once or several times. Further, the accumulation may be continued without changing the accumulation form, i.e., in the accumulation form at the time of accumulation. Hereinafter, a process of accumulating the data in the accumulation unit 24 performed when the data is acquired will be referred to as initial accumulation.

When performing the initial accumulation, the user gives a data classification to the MFP 1. The MFP 1 executes the initial accumulation and the reaccumulation in the initially set accumulation form in accordance with the given classification. When the degree of importance of the data is low, the user can give not only the data classification but also the accumulation form of the data to the MFP 1. At this time, the initial accumulation can be executed by the MFP 1 in the accumulation form directly specified by the user. Further, when the degree of importance of the data is low, the user can give the accumulation form of the data to the MFP 1 when reaccumulating the data. At this time, the reaccumulation can be executed by the MFP 1 in the accumulation form directly specified by the user.

FIG. 2 is a schematic view illustrating an example of the data stored in the accumulation-form storage unit. Each accumulation information on the data classification, the timing at which the accumulation form of the accumulated data should be changed (hereinafter referred to as a change timing), and the accumulation form of the data after the change, is stored in advance in the accumulation-form storage unit 131 in association with each other. Moreover, the accumulation-form storage unit 131 also functions as an initial-form storage unit. Each accumulation information on the data classification and the accumulation form of the data to be acquired is stored in advance in the accumulation-form storage unit as the initial-form storage unit in association with each other.

The data to be stored in the accumulation-form storage unit 131 can be stored in advance in the accumulation-form storage unit 131, for example, by being input into the MFP 1 by use of the operation unit 15 or transmitted from a personal computer to the MFP 1 by a manufacturer or an administrator etc. of the MFP 1.

Accumulation information, such as information indicating whether the data is text data or image data, or information indicating whether or not a document is important, can be used as the “data classification”. Accumulation information, such as information indicating whether or not to compress, information indicating whether to continue or delete the accumulation, information indicating whether the compression is lossy or lossless, information indicating whether a compression format includes high compressibility or low compressibility, and information indicating whether the compression format requires a long time or short time for the compression and/or decompression, can be used as the “accumulation form”, and the appropriate accumulation form can be associated in accordance with the data classification. In the present preferred embodiment, data deletion is handled as a type of accumulation form. Data transfer to a hard disk, a file server, a CD-R or the like arranged outside the MFP 1 may also be handled as a type of accumulation form.

Counting is started at a data scanning time in the scanner unit 19, at a data transmission time in the I-FAX machine, a data generation time in the personal computer, a data storing time in the RAM 12 or the image memory 21, and a data initial-accumulation time in the accumulation unit 24, or the like (hereinafter, the times are collectively referred to as an accumulation date and time). A timing when a predetermined time has elapsed (for example, one year later, five years later, or ten years later) from the start of such counting is used as the “change timing”. In other words, an appropriate accumulation duration period is associated in accordance with the data classification. The date and time may also be used as the change timing. A change timing or a plurality of change timings may be associated with each classification, however, when a plurality of change timings is set, mutually different accumulation forms are associated with the corresponding change timings.

Further, the accumulation form is set such that the amount of data (i.e., an amount that occupies the accumulation area of the accumulation unit 24) is reduced from the accumulation form of the initial accumulation, the accumulation form of the “N”th (“N” is a natural number) reaccumulation, and the accumulation form of the “N”th+1 reaccumulation, in this order. Furthermore, as the degree of importance of data lowers, the accumulation form with the less amount of data (i.e., the amount that occupies the accumulation area of the accumulation unit 24) is associated with each of the data classifications.

More specifically, as illustrated in FIG. 2, a “classification name”, a “data type”, and the “degree of importance” are associated as the “data classification”. The data type of text data and document data edited by using word processor software or the like is a “document”, the data type of the original image data generated by the scanner unit 19 or by using paint software or the like is an “image”, and the data type of the FAX image data and the FAX mail is a “FAX/I-FAX”. The degree of importance is represented as “high” or “low”.

The “classification name” is assigned to the data of such data type and degree of importance. The document of high importance is referred to as an “important document”, the document of low importance is referred to as a “simple document”, the image of high importance is referred to as an “important image”, and the image of low importance is referred to as a “simple image”. A FAX number and a mail address may also be used as the classification name. The “initial accumulation form”, which is associated with the data classification, is the accumulation form of the initial accumulation, i.e., the accumulation form of the data acquired by the scanner unit 19, the modem 18 or the like.

A “first change timing” and a “second change timing” or the like, which are associated with the data classification, are the timings at which the accumulation form of the accumulated data should be changed. The accumulation duration period from the accumulation date and time to the “N”th+1 change timing is set to be longer than the accumulation duration period from the accumulation date and time to the “N”th change timing. A “first accumulation form” and a “second accumulation form” or the like are the accumulation forms of the data after the accumulation form is changed, and are directly associated with the first change timing and the second change timing or the like. The first accumulation form and the second accumulation form or the like are set such that the amount of data of the first accumulation form is less than the amount of data of the initial accumulation form, and that the amount of data of the “N”th+1 accumulation form is less than the amount of data of the “N”th accumulation form.

The data classified as the important document is compressed into a ZIP format with low compressibility (“ZIP-low” in the drawing), and accumulated at the time of initial accumulation. Then, “five years later” from the accumulation date and time, after being decompressed once, the data is compressed into a ZIP format with high compressibility (“ZIP-high” in the drawing), and reaccumulated. The data compressed with high compressibility has an advantage in that an occupying amount thereof in the accumulation area of the accumulation unit 24 is small, however, a disadvantage is that data degradation occurs or the compression/decompression requires a substantial time. The data classified as the simple document is compressed into the ZIP format with high compressibility (“ZIP-high” in the drawing), and accumulated at the time of initial accumulation. Then, the data is “deleted” “one year later” from the accumulation date and time.

The data classified as the important image is compressed into an LZH format (“LZH” in the drawing), which is lossless compression, and accumulated at the time of initial accumulation. Then, “one year later” from the accumulation date and time, after being once decompressed, the data is compressed into a Joint-Photographic-Experts-Group (JPEG) format that is lossy compression and has a short compression/decompression time (“JPEG-short” in the drawing), and reaccumulated. The reaccumulated data is once again decompressed “five years later” from the accumulation date and time. Then, the data is compressed into a JPEG format that is the lossy compression and has a long compression/decompression time (“JPEG-long” in the drawing), and reaccumulated.

The data on which the lossy compression has been performed occupies a smaller amount in the accumulation area of the accumulation unit 24, however, the data degradation occurs. The data with the long compression/decompression time occupies a smaller amount in the accumulation area of the accumulation unit 24, however, a substantial time is required to decompress and read out the data. The data classified as the simple image is compressed into the JPEG format that has the short compression/decompression time (“JPEG-short” in the drawing), and accumulated at the time of initial accumulation. Then, “three years later” from the accumulation date and time, after being once decompressed, the data is compressed into the JPEG format that has the long compression/decompression time (“JPEG-long” in the drawing), and reaccumulated.

The accumulation format the time of initial accumulation and a combination of the change timing and the accumulation form are not limited to the above-described combination. For example, the data may be accumulated without being compressed at the time of initial accumulation, then, compressed and reaccumulated a week later, or may remain in a compressed state of the initial accumulation. Moreover, the second and subsequent reaccumulations may be performed when a prescribed time has elapsed from the previous reaccumulation time. Further, at the time of reaccumulation, unless the user specifies the accumulation form, the previous accumulation form may remain. Furthermore, audio data and dynamic image data etc. may be handled. In addition, the format is not limited to the ZIP format, the LZH format, and the JPEG format, and may be a Moving Picture Experts Group (MPEG) format and an MP3 format or the like.

In the ZIP format, the degree of compressibility of the ZIP format can be adjusted by changing a parameter that is relative to the compressibility. In the JPEG format, the length of compression/decompression time of the JPEG format can be adjusted by changing a parameter that is relative to the compression/decompression time. The parameter is not limited to the above-described parameters, and for example, the occupied amount in the accumulation area of the accumulation unit 24 may be reduced by changing a compression block size.

The operation unit 15 is controlled by the CPU 10 and functions as a classification accepting unit. More specifically, four function keys for selecting any one of the important document, the simple document, the important image, or the simple image, are generated on the touchscreen of the operation unit 15 by the CPU 10. At this time, an image indicating the position of the key and a character image indicating the classification name are displayed on the display unit 14 in association with each of the generated function keys.

When the MFP 1 acquires data by having the data transmitted from the personal computer to the MFP 1 or by having an original document scanned by the scanner unit 19, the user who has transmitted the data from the personal computer to the MFP 1 or the user who has scanned the original document by the scanner unit 19 gives the data classification to the operation unit 15 by operating the operation unit 15 while checking the display unit 14. Alternatively, the data classification may be transmitted from the personal computer to the MFP 1.

When the MFP 1 acquires data by receiving a FAX mail from the I-FAX machine or by receiving FAX image data from the FAX machine, the modem 18 and the I/F 16 separately function as the classification accepting units. In other words, by acquiring the FAX number received along with the FAX image data and acquiring the mail address included in the header of the FAX mail, the data classification is given to each of the FAX image data and the FAX mail. An example will be described below in which the operation unit 15 is used as the classification accepting unit.

FIG. 3 is a schematic view illustrating the example of the data stored in the classification storage unit. The classification storage unit 132 stores the classification accepted by the operation unit 15 in accordance with the data to be accumulated in the accumulation unit 24. More specifically, the “classification name” and the “degree of importance” are associated as the “data classification”. Moreover, the “accumulation date and time”, a “data name” (for example, a file name and an identification number or the like) of the data to be accumulated in the accumulation unit 24, and a “next change timing”, which is to be referred next at the accumulation form storage unit 131, are stored as the accumulation information in association with the data classification.

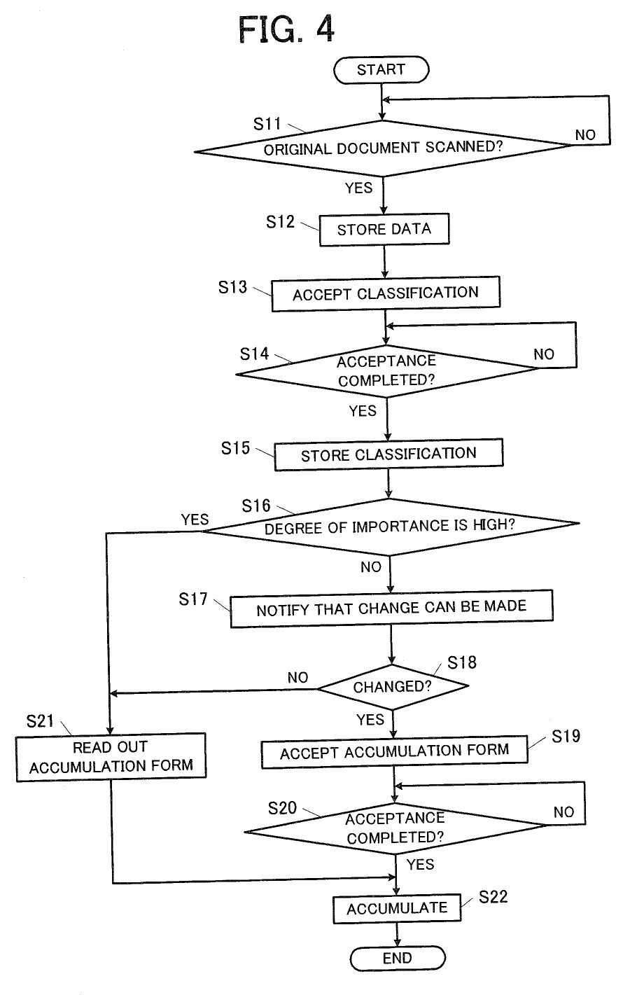

FIG. 4 is a flow chart illustrating the procedure of the initial accumulation process executed by the CPU 10. An example will be described below in which normal image data acquired by having the original document scanned by the scanner unit 19 is accumulated, however, a substantially similar procedure may be executed when accumulating the received data. The acceptance of the data classification in each of the FAX communication and the I-FAX communication is automatically performed without the operation of the operation unit 15 performed by the user.

The CPU 10 determines whether or not the scanner unit 19 has started scanning the original document (S11), and when the original document has not been scanned (“NO” in S11), the process in S11 is repeated. When the scanner unit 19 has started scanning the original document (“YES” in S11), the CPU 10 stores in the image memory 21 the original image data (hereinafter, abbreviated as the data) acquired by having the original document scanned by the scanner unit 19 (S12).

Then, the CPU 10 accepts the data classification (more specifically, the classification name) at the operation unit 15 (S13). Further, the CPU 10 determines whether or not the operation of the operation unit 15 performed by the user has been completed, i.e., the CPU 10 determines whether or not the acceptance of the data classification has been completed (S14). When the acceptance has not been completed (“NO” in S14), the process in S14 is repeated. The processes in S13 and S14 may be executed before the process in S11. When the acceptance of the data classification at the operation unit 15 has been completed (“YES” in S14), the CPU 10 associates the data classification accepted in S14 with the data to be accumulated in S22 to be described later (i.e., the data acquired in S11) to store in the classification storage unit 132 (S15).

More specifically, the CPU 10 in S15 refers to the accumulation-form storage unit 131, acquires the degree of importance that is associated with the classification name accepted in S14, and determines whether or not the first change timing is associated with the classification name accepted in S14.

Then, the CPU 10 associates the classification name accepted in S14, the degree of importance acquired from the accumulation-form storage unit 131, the data name of the data acquired by being scanned in S11, the accumulation date and time, and that the next change timing is the first change timing, with each other to store in the classification storage unit 132. However, when the first change timing is not associated with the classification name accepted in S14, the accumulation information on the next change timing is not stored. Here, the date and time at which the scanner unit 19 scanned the original document are used as the accumulation date and time. As for the data name, the CPU 10 properly generates a name as the data name, or the CPU 10 accepts a name from the user via the operation unit 15.

Then, the CPU 10 determines whether or not the degree of data importance included in the classification accepted in S14 (more specifically, the degree of importance stored in the accumulation-form storage unit 131 in association with the accepted classification name) is high (S16). When the degree of importance of the data is low (“NO” in S16), the CPU 10 displays on the display unit 14 an image notifying the user that the accumulation form can be changed, and an image for the user to select whether or not to change (S17). Then, the CPU 10 displays on the operation unit 15 a function key for changing the accumulation form and a function key for not changing the accumulation form, and determines whether or not the function key for changing the accumulation form has been operated (S18).

When the function key for changing the accumulation form has been operated (“YES” in S18), the CPU 10 accepts the accumulation form of the data at the operation unit 15 (S19). Further, the CPU 10 determines whether or not the operation at the operation unit 15 by the user has been completed, i.e., the CPU 10 determines whether or not the acceptance of the accumulation form of the data has been completed (S20), and when the operation (the acceptance) has not been completed (“NO” in S20), the process in S20 is repeated.

When the degree of importance of the data is high (“YES” in S16), when the function key for not changing the accumulation form has been operated, or when the function key for changing the accumulation form has not been operated even after the predetermined time elapsed from the completion of the process in S17 (“NO” in S18), the CPU 10 reads out the initial accumulation form stored in the accumulation-form storage unit 131 in association with the classification accepted in S14 (S21). Further, the CPU 10 reads out the data stored in the image memory 21 in S12, and accumulates in the accumulation unit 24 the read out data in the accumulation form read out in S21 (S22).

When the acceptance of the accumulation form of the data has been completed (“YES” in S20), the CPU 10 proceeds the process to S22, where the CPU 10 reads out the data stored in the image memory 21 in S12, and accumulates in the accumulation unit 24 the read out data in the accumulation form accepted in S20.

In such an initial accumulation process of S11, the CPU 10 controls the scanner unit 19 and functions as an acquiring unit. In S22, the CPU 10 functions as a first accumulation control unit. In S13, the CPU 10 controls the operation unit 15 and functions as a classification accepting unit. In S15, the CPU 10 controls the classification storage unit 132. When “YES” is selected in S16, or when “NO” is selected in S17, in S22, the CPU 10 accumulates in the accumulation unit the data acquired by the acquiring unit, in the accumulation form stored in the initial-form storage unit in association with the classification accepted by the classification accepting unit.

Further, in S19, the CPU 10 controls the operation unit 15 and functions as an initial-form accepting unit. In S20, the CPU 10 functions as an initial-acceptance-determining unit. When “YES” is selected in S20, the CPU 10 in S22 accumulates in the accumulation unit the data acquired by the acquiring unit, in the accumulation form accepted by the initial-form accepting unit. Furthermore, in accordance with a result of the process in S16, i.e., in accordance with the degree of importance of the data, the acceptance of the accumulation form performed by the initial-form accepting unit is prohibited or executed.

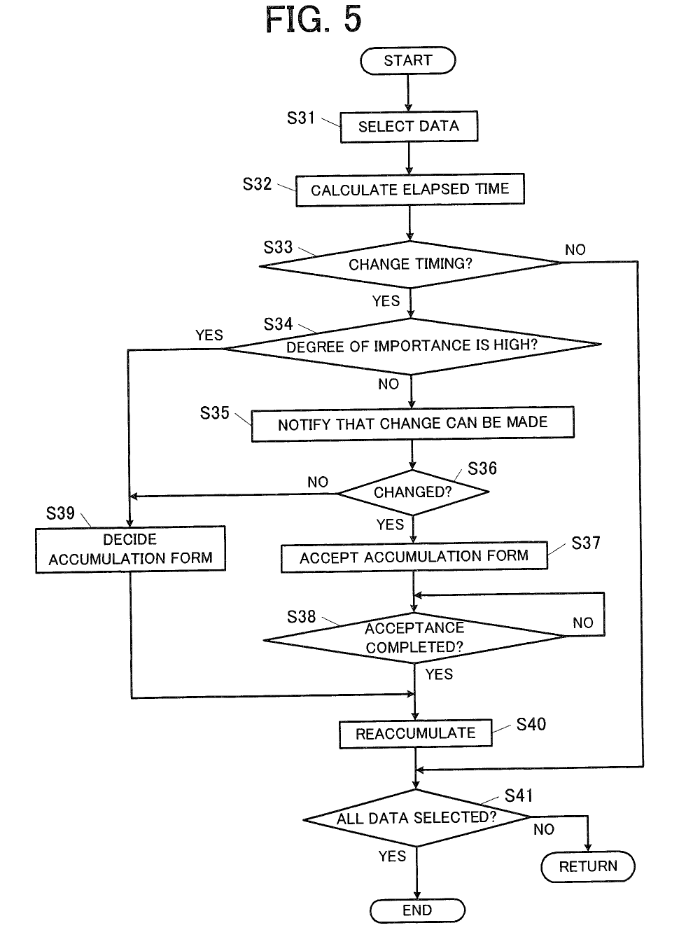

FIG. 5 is a flow chart illustrating the procedure of the reaccumulation process executed by the CPU 10. The execution of the reaccumulation process is started, for example, at a prescribed time once a day. The CPU 10 selects one of the data accumulated in the accumulation unit 24 (S31).

The CPU 10 refers to the classification storage unit 132, selects the data name, and acquires the next change timing, the accumulation date and time, the classification name, and the degree of importance, all of which are associated with the selected data name. Moreover, in association with the selected data name, “1” is set to a flag indicating that the data has been selected. Further, the CPU 10 refers to the accumulation-form storage unit 131, and acquires a specific numeric value of the next change timing and the accumulation form in accordance with the classification name of the data and the next change timing that are acquired from the classification storage unit 132.

At this time, in the example illustrated in FIG. 3, “data1.jpg”, in which the next change timing does not exist, is not selected, but “data2.doc”, in which the next change timing is the “first change timing”, is selected, and the accumulation date and time “2004.02.13”, the classification name “important document”, and the degree of importance “high”, all of which are associated with “data2.doc”, can be acquired from the classification storage unit 132. Further, the specific numeric value “five years later” and the accumulation form “ZIP-high”, which are associated with the “important document” and with the “first change timing”, can be acquired from the accumulation-form storage unit 131.

The CPU 10 calculates the time elapsed from the accumulation date and time in accordance with the accumulation date and time acquired from the classification storage unit 132 and with the current date and time counted by the timer 25 (S32). In accordance with the calculated elapsed time, the CPU 10 determines whether or not the current time is the change timing acquired from the accumulation-form storage unit 131 (S33). When the current time is the change timing of the data (“YES” in S33), the CPU 10 determines whether or not the degree of importance acquired from the classification storage unit 132 is high (S34). When the degree of importance is low (“NO” in S34), the CPU 10 accordingly executes the processes in S35 through S38 that are substantially similar to the processes in S17 through S20.

When the degree of importance acquired from the classification storage unit 132 is high (“YES” in S34), when the function key for not changing the accumulation form has been operated, or when the function key for changing the accumulation form has not been operated even after the predetermined time elapsed from the completion of the process in S35 (“NO” in S36), the CPU 10 decides that the accumulation form after the change will be the accumulation form acquired from the accumulation form storage unit 131 (S39).

Further, the CPU 10 reads out from the accumulation unit 24 the data selected in S31, i.e., the data including the data name acquired from the classification storage unit 132, and reaccumulates in the accumulation unit 24 the read out data in the accumulation form determined in S39 (S40). When the data read out from the accumulation unit 24 has been compressed, the CPU 10 once decompresses the data to reaccumulate.

When the acceptance of the accumulation form of the data is completed (“YES” in S38), the CPU 10 proceeds the process to S40, reads out from the accumulation unit 24 the data selected in S31, and reaccumulates in the accumulation unit 24 the read out data, in the accumulation form accepted in S38 (S40). After the end of the process of S40, the CPU 10 refers to the accumulation-form storage unit 131, and changes the next change timing stored in the classification storage unit 132 to the further next change timing.

After the end of the process of S40, or when the current time is not the change timing of the data (“NO” in S33), the CPU 10 determines whether or not all of the data accumulated in the accumulation unit 24 have been selected (S41). Accordingly, the CPU 10 refers to the classification storage unit 132, and selects the data in which “1” is not set to the flag indicating that the data has been selected and in which the next change timing is stored in association with the data name.

When the not-yet-selected data exists (“NO” in S41), the CPU 10 returns the process to S31. When the selection is ended (“YES” in S41), the CPU 10 resets all of the flags, which indicate that the data has been selected, to “0” in the classification storage unit 132, and ends the reaccumulation process. Alternatively, the acceptance of the accumulation form in S37 may be performed with respect to all of the data whose accumulation form is to be changed, and then, the reaccumulation of each data may be executed in S40.

In such a reaccumulation process of S31, the CPU 10 functions as a selection unit. In S33, the CPU 10 functions as a timing determining unit. In S40, the CPU 10 functions as a second accumulation control unit. When “YES” is selected in S34, or when “NO” is selected in S36, in S40, the CPU 10 accumulates in the accumulation unit the data selected by the selection unit, in the accumulation form stored in the accumulation-form storage unit in association with the classification accepted by the classification accepting unit and with the timing determined by the timing determining unit to have come.

Further, in S37, the CPU 10 controls the operation unit 15 and functions as an accumulation-form accepting unit. In S38, the CPU 10 functions as a form-acceptance determining unit. When “YES” is selected in S38, in S40, the CPU 10 reaccumulates in the accumulation unit the data selected by the selection unit, in the accumulation form accepted by the accumulation-form accepting unit. Furthermore, in accordance with the result of the process of S34, i.e., in accordance with the degree of importance of the data, the acceptance of the accumulation form performed by the accumulation-form accepting unit is prohibited or executed.

In the above-described MFP 1, the user can easily specify the appropriate accumulation form and the timing at which the accumulation form is changed, with respect to each of the data to be accumulated, and when the degree of importance of the data is low, the data can be accumulated or reaccumulated in the accumulation form re-specified by the user.

Moreover, when the data is the image data, thumbnails of the image data may be stored in the accumulation unit 24. Further, when the data is the dynamic image data, still image data generated by extracting a portion of the dynamic image data may be stored in the accumulation storage unit 24. Furthermore, data generated by extracting a portion of text data or audio data or the like may be stored in the accumulation unit 24.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An accumulation control device arranged to accumulate data in an accumulation device, comprising:
an acquiring unit arranged to acquire the data;
a first accumulation control unit arranged to accumulate in the accumulation device the data acquired by the acquiring unit;
a classification accepting unit arranged to accept a data classification when the acquiring unit acquires the data;
a classification storage unit arranged to store the classification accepted by the classification accepting unit, in accordance with the data to be accumulated in the accumulation device;
an accumulation-form storage unit arranged to store the data classification, a timing at which an accumulation form of the accumulated data should be changed, and the accumulation form after the change, in association with each other;
a selection unit arranged to select the data accumulated in the accumulation device;
a timing determining unit arranged to determine whether or not the timing stored in the accumulation-form storage unit in association with the classification stored in the classification storage unit has come, in accordance with the data selected by the selection unit; and
a second accumulation control unit arranged, when the timing determining unit determines that the timing has come, to reaccumulate in the accumulation device the data selected by the selection unit, in the accumulation form stored in the accumulation-form storage unit in association with the classification and the timing determined by the timing determining unit.

2. The accumulation control device according to claim 1, further comprising:
an accumulation-form accepting unit arranged to accept the accumulation form of the accumulated data; and
a form-acceptance determining unit arranged to determine whether or not the accumulation-form accepting unit has accepted the accumulation form,
wherein when the form-acceptance determining unit determines that the accumulation form has been accepted, and when the timing determining unit determines that the timing has come, the second accumulation control unit reaccumulates in the accumulation device the data selected by the selection unit, in the accumulation form accepted by the accumulation-form accepting unit.

3. The accumulation control device according to claim 2, wherein the classification to be accepted by the classification accepting unit includes at least a degree of importance of the data, and
the acceptance of the accumulation form performed by the accumulation-form accepting unit is prohibited or executed in accordance with the degree of importance of the data.

4. The accumulation control device according to claim 2, wherein the degree of importance of the data is stored in the accumulation-form storage unit in association with the classification of the data to be accumulated, and
the acceptance of the accumulation form performed by the accumulation-form accepting unit is prohibited or executed in accordance with the degree of importance of the data.

5. The accumulation control device according to claim 1, further comprising an initial-form storage unit arranged to store the data classification and the accumulation form of the data to be acquired, in association with each other,
wherein the first accumulation control unit accumulates in the accumulation device the data acquired by the acquiring unit, in the accumulation form stored in the initial-form storage unit in association with the classification accepted by the classification accepting unit.

6. The accumulation control device according to claim 5, further comprising:
an initial-form accepting unit arranged to accept the accumulation form of the data acquired when the data is acquired by the acquiring unit; and
an initial-acceptance determining unit arranged to determine whether or not the initial-form accepting unit has accepted the accumulation form,
wherein when the initial-acceptance determining unit determines that the accumulation form has been accepted, the first accumulation control unit accumulates in the accumulation device the data acquired by the acquiring unit, in the accumulation form accepted by the initial-form accepting unit.

7. The accumulation control device according to claim 6, wherein the classification to be accepted by the classification accepting unit includes at least a degree of importance of the data, and
the acceptance of the accumulation form performed by the accumulation-form accepting unit is prohibited or executed in accordance with the degree of importance of the data.

8. The accumulation control device according to claim 6, wherein the degree of importance of the data is stored in the accumulation-form storage unit in association with the classification of the data to be accumulated, and
the acceptance of the accumulation form performed by the accumulation-form accepting unit is prohibited or executed in accordance with the degree of importance of the data.

9. The accumulation control device according to claim 1, wherein the data classification includes at least one of the following: information indicating whether or not the data is text data; information indicating whether or not the data is image data; and information indicating whether or not a document is important.

10. The accumulation control device according to claim 1, wherein the accumulation form includes at least one of the following: information indicating whether or not to compress the data; information indicating whether or not to continue the accumulation of the data; information indicating whether or not to losslessly compress the data; information indicating whether or not a compression format includes high compressibility; and information indicating whether or not the compression format requires a substantial time for the compression/decompression.

11. The accumulation control device according to claim 1, wherein the change timing is a timing when a predetermined time has elapsed from the start of counting that is started at at least one of the following times: a data scanning time; a data transmission time; a data generation time; a data storing time; and a data initial-accumulation time in the accumulation device.

12. The accumulation control device according to claim 1, wherein the accumulation device is a hard disk or a file server arranged outside the accumulation control device.

13. An accumulation device comprising:
an accumulation unit arranged to accumulate data;
an acquiring unit arranged to acquire the data;
a first accumulation control unit arranged to accumulate in the accumulation unit the data acquired by the acquiring unit;
a classification accepting unit arranged to accept a data classification when the acquiring unit acquires the data;
a classification storage unit arranged to store the classification accepted by the classification accepting unit, in accordance with the data to be accumulated in the accumulation unit;
an accumulation-form storage unit arranged to store the data classification, a timing at which an accumulation form of the accumulated data should be changed, and the accumulation form after the change, in association with each other;
a selection unit arranged to select the data accumulated in the accumulation unit;
a timing determining unit arranged to determine whether or not the timing stored in the accumulation-form storage unit in association with the classification stored in the classification storage unit has come, in accordance with the data selected by the selection unit; and
a second accumulation control unit arranged, when the timing determining unit determines that the timing has come, to reaccumulate in the accumulation unit the data selected by the selection unit, in the accumulation form stored in the accumulation-form storage unit in association with the classification and the timing determined by the timing determining unit.

14. The accumulation device according to claim 13, further comprising:
an accumulation-form accepting unit arranged to accept the accumulation form of the accumulated data; and
a form-acceptance determining unit arranged to determine whether or not the accumulation-form accepting unit has accepted the accumulation form,
wherein when the form-acceptance determining unit determines that the accumulation form has been accepted, and when the timing determining unit determines that the timing has come, the second accumulation control unit reaccumulats in the accumulation unit the data selected by the selection unit, in the accumulation form accepted by the accumulation-form accepting unit.

15. The accumulation device according to claim 14, wherein the classification to be accepted by the classification accepting unit includes at least a degree of importance of the data, and
the acceptance of the accumulation form performed by the accumulation-form accepting unit is prohibited or executed in accordance with the degree of importance of the data.

16. The accumulation device according to claim 14, wherein the degree of importance of the data is stored in the accumulation-form storage unit in association with the classification of the data to be accumulated, and
the acceptance of the accumulation form performed by the accumulation-form accepting unit is prohibited or executed in accordance with the degree of importance of the data.

17. The accumulation device according to claim 13, further comprising an initial-form storage unit arranged to store the data classification and the accumulation form of the data to be acquired, in association with each other,
wherein the first accumulation control unit accumulates in the accumulation unit the data acquired by the acquiring unit, in the accumulation form stored in the initial-form storage unit in association with the classification accepted by the classification accepting unit.

18. The accumulation device according to claim 17, further comprising:
an initial-form accepting unit arranged to accept the accumulation form of the data acquired when the data is acquired by the acquiring unit; and
an initial-acceptance determining unit arranged to determine whether or not the initial-form accepting unit has accepted the accumulation form,
wherein when the initial-acceptance determining unit determines that the accumulation form has been accepted, the first accumulation control unit accumulates in the accumulation unit the data acquired by the acquiring unit, in the accumulation form accepted by the initial-form accepting unit.

19. The accumulation device according to claim 18, wherein the classification to be accepted by the classification accepting unit includes at least a degree of importance of the data, and
the acceptance of the accumulation form performed by the accumulation-form accepting unit is prohibited or executed in accordance with the degree of importance of the data.

20. The accumulation device according to claim 18, wherein the degree of importance of the data is stored in the accumulation-form storage unit in association with the classification of the data to be accumulated, and
the acceptance of the accumulation form performed by the accumulation-form accepting unit is prohibited or executed in accordance with the degree of importance of the data.

21. The accumulation device according to claim 13, wherein the data classification includes at least one of the following: information indicating whether or not the data is text data; information indicating whether or not the data is image data; and information indicating whether or not a document is important.

22. The accumulation device according to claim 13, wherein the accumulation form includes at least one of the following: information indicating whether or not to compress the data; information indicating whether or not to continue the accumulation of the data; information indicating whether or not to loselessly compress the data; information indicating whether or not a compression format includes high compressibility; and information indicating whether or not the compression format requires a substantial time for the compression/decompression.

23. The accumulation device according to claim 13, wherein the change timing is a timing when a predetermined time has elapsed from the start of counting that is started at at least one of the following times: a data scanning time; a data transmission time; a data generation time; a data storing time; and a data initial-accumulation time in the accumulation unit.

24. The accumulation device according to claim 13, wherein the accumulation unit is arranged inside the accumulation device.

25. An accumulation control method arranged to accumulate data in an accumulation device, the accumulation control method comprising the steps of:
acquiring the data;
accumulating the acquired data in the accumulation device;
accepting a data classification when the data is acquired;
storing the accepted classification in accordance with the data to be accumulated in the accumulation device;
storing the data classification, a timing at which an accumulation form of the accumulated data should be changed, and the accumulation form after the change, in association with each other;
selecting the data accumulated in the accumulation device;
determining whether or not the timing stored in association with the stored classification has come, in accordance with the selected data; and
reaccumulating, when determined that the timing has come, the selected data in the accumulation device, in the accumulation form stored in association with the classification and the determined timing.
